(19) United States
(12) Patent Application Publication
(10) Pub. No.: US 2012/0269321 A1
(43) Pub. Date: Oct. 25, 2012

(54) SWITCHING OF ANODE POTENTIAL OF AN X-RAY GENERATING DEVICE

(75) Inventor: Rolf Karl Otto Behling, Norderstedt (DE)

(73) Assignee: KONINKLIJKE PHILIPS ELECTRONICS N.V., EINDHOVEN (NL)

(21) Appl. No.: 13/501,259

(22) PCT Filed: Oct. 21, 2010
(86) PCT No.: PCT/IB2010/054762

§ 371 Date: Apr. 11, 2012

(30) Foreign Application Priority Data
Oct. 28, 2009 (EP) 09174304.7

(51) Int. Cl. H01J 35/30; H01J 35/14; G01N 23/04; H05G 1/08; H01J 35/04; H01J 35/08; B82Y 99/00

(52) U.S. Cl. 378/62; 378/121; 378/138; 378/137; 378/124; 378/91; 977/742; 977/950

(57) ABSTRACT

The present invention relates to X-ray generating technology in general. Providing X-radiation having multiple photon energies may help differentiating tissue structures when generating X-ray images. Consequently, an X-ray generating device that allows the switching of a potential of an electron collecting element versus an electron emitting element for providing different energy modes is presented. According to the present invention, an X-ray generating device is provided, comprising an electron emitting element (16) and electron collecting element (20). The electron emitting element (16) and the electron collecting element (20) are operatively coupled for the generation of X-radiation (14). A potential is arranged between the electron emitting element (16) and the electron collecting element (20) for acceleration of electrons from the electron emitting element 16 to the electron collecting element (20), the electrons constituting an electron beam (7). The electron beam (17) is adapted to influence the potential.

### TECHNICAL FIELD OF THE INVENTION

The present invention relates to X-radiation generating technology in general. More particularly, the present invention relates to an X-ray generating device, an X-ray system, the use of an X-ray generating device in at least one of an X-ray system and a CT system and a method for switching electron collecting element potential. In particular, the present invention relates to an X-ray generating device having a switchable potential for the acceleration of electrons.

### BACKGROUND OF THE INVENTION

X-ray generating devices, also known as e.g. X-ray tubes, may be employed for generating electro-magnetic radiation used for medical imaging applications, inspection imaging applications or security imaging applications.

An X-ray generating device may comprise an electron emitting element, e.g. a cathode element, and an electron collecting element, e.g. an anode element. Electrons are accelerated from the electron emitting element to the electron collecting element by a potential between said two elements for generating X-radiation.

The electrons emanating from the electron emitting elements travel to the electron collecting element and arrive at an area called the focal spot, so creating electro-magnetic radiation by electron bombardment of, e.g. a disc element of, the electron collecting element. Electron collecting elements or anode elements may be of a static nature or may be implemented as rotating elements.

One application of an X-ray tube for example is in a computed tomography system or CT system. An X-ray tube is rotating about an object, e.g. a patient, while generating a fan beam of X-rays. Situated opposite of the X-ray tube, however with it on a gantry, an X-ray detector element is arranged, which rotates with the X-ray tube about the object. The detector converts X-radiation, especially X-radiation attenuated by the object, to electrical signals for subsequent reconstruction and display of an image of an object's inner morphology by e.g. a computer system.

Multiple X-radiation photon energies may be beneficial when generating an X-ray image for differentiating individual tissue of e.g. a patient.

### SUMMARY OF THE INVENTION

Thus, there may be a need to provide an X-ray generating device capable of generating X-radiation having multiple, individual and distinct photon energies. The photon energy of X-radiation may be considered to be dependent on the voltage or potential difference between an electron emitting element and an electron collecting element used for accelerating electrons.

In the following, an X-ray generating device, an X-ray system, use of an X-ray generating device in at least one of an X-ray system and a CT system and a method for switching electron collecting element potential according to the independent claims are provided.

According to an exemplary embodiment of the present invention, an X-ray generating device is provided, comprising an electron emitting element and an electron collecting element. The electron emitting element and the electron collecting element are operatively coupled for the generation of X-radiation. A potential is arranged between the electron emitting element and the electron collecting element for acceleration of the electrons from the electron emitting element to the electron collecting element. The electrons so accelerated constitute an electron beam. The electron beam is further adapted to influence the potential.

According to a further exemplary embodiment of the present invention, an X-ray system is provided, comprising an X-ray generating device according to the present invention and an X-ray detector. An object is arrangeable between the X-ray generating device and the X-ray detector and the X-ray generating device and the X-ray detector are operatively coupled such that an X-ray image of the object is obtainable.

According to a further exemplary embodiment of the present invention, an X-ray generating device according to the present invention is used in at least one of an X-ray system and a CT-system.

According to a further exemplary embodiment of the present invention, a method for switching electron collecting element potential is provided, comprises providing an electron beam from an electron emitting element to a first area of impingement of an electron collecting element for generating X-radiation, wherein the electron beam may be provided, at least in part, to a second area of impingement for changing a potential between the electron emitting element and the electron collecting element.

As already pointed out, employing multiple X-radiation photon energies for the generation of images may help differentiating internal structures of an object to be examined, e.g. individual types of tissue of a patient. The pulse time of periods with high energy and periods with low energy may be required to be less than the integration period of an X-ray detector, which may be for example 200 μsec in case of a CT scanner. The transition time between high energy and low energy periods may be required to be even shorter.

The high voltage generator, to which the X-ray generating device, e.g. an X-ray tube, is connected to, may be employed for altering the tube voltage, thus the potential between a cathode element and an anode element. However, capacities may be present at the generator output, the high voltage cable and/or the anode that may prevent discharging with a speed that would allow a preferred switching between high energy periods and low energy periods within or by the voltage generator.

One solution to decrease transition time between high energy and low energy periods may be seen as altering a potential, thus the voltage difference between the electron emitting element and the electron collecting element.

X-ray generating devices may be implemented as either unipolar or bipolar X-ray generating devices. In a unipolar configuration, a negative voltage may be provided to the electron emitting element while the electron collecting element is connected to ground potential. In a bipolar configuration the electron collecting element may even be provided with a positive voltage.

One aspect of the invention may be seen as providing switching between ground potential and positive voltage potential of the electron collecting element. With the voltage provided to the electron emitting element substantially remaining constant, the voltage difference between the electron emitting element and the electron collecting element, thus the potential, may be influenced, e.g. increased for providing increased photon energies in a high energy period with positive voltage provided to the electron collecting elements and low energy periods in case the electron collecting element is substantially connected to ground potential.

To allow for an according quick adjustment of electron collecting element potential, the electron collecting element, which may be regularly connected to ground potential, may be required to be electrically decoupled from ground potential, thus from the capacitance of the high voltage supply or high voltage generator.

An according decoupling may be performed by connecting a resistor, an inductance or a diode element between the electron collecting element and ground potential. A dedicated capacitance, which may also be the parasitic capacitance of the electron collecting element, may be connected in parallel to said element for decoupling.

Thus, the electron collecting element may be considered to be an element having a floating potential, e.g. a floating electrode. The potential of a floating electrode may thus be changed to the positive and/or negative by a controlled impingement of electrons. For controlling the potential of the electron collecting element and thus the photon energy of X-radiation, a supplementary electron collecting element, e.g. a supplementary anode element, may be provided, which may be connected directly to ground potential.

The electron beam regularly impinging on the focal spot or focal track in case of a rotating electron collecting element, may be deflected, at least in part by deflection elements, e.g. electromagnetic lenses, to impinge on a supplementary focal spot or focal track, arranged on the supplementary electron collecting element.

X-radiation generated by the impingement of electrons on the supplementary focal track may be retained inside the X-ray generating device, e.g. by an aperture element or a collimation element. Accordingly, the supplementary electron collecting element may be considered to be a beam dump.

Due to only a part of the initial electron beam impinging on the electron collecting element, there may occur a change in current through the resistor or inductance between the electron collecting element and ground potential, which may thus change or influence the potential of the electron collecting element and thus the beam energy of the X-radiation.

In case the X-ray generating device is required to be operating in a single energy mode only, the electron beam may be completely deflected towards the supplementary focal track with the aperture elements of the X-ray generating device being relocated to correspond to the supplementary focal track for the creation of an X-ray beam leaving the X-ray generating device, thus contributing to the generation of X-ray images. The resistor element or inductance element may be considered to be bypassed and out of operation in the single energy mode.

A further possibility to provide a change in potential of the electron collecting element, e.g. in case the electron collecting element is decoupled from ground potential by e.g. a diode, may be providing a supplementary electron collector or a scattered electron collecting element, which is e.g. directly connected to a positive voltage, thus a positive potential compared to ground potential.

A further area of impingement of the electron collecting element besides the focal spot or focal track may be provided. The second area of impingement may be adapted to provide electron scattering. Electrons scattered may thus be directed towards the scattered electron collecting element and consequently the electron collecting element may be positively charged or ionized, thus obtaining a potential similar to the scattered electron collecting element. Consequently, the potential of the electron collecting element is changed from ground potential to positive potential, increasing the overall potential or voltage difference between the electron emitting element and the electron collecting element.

Obtaining positive potential by electron scattering may be provided in particularly beneficial by electron back scatter ratios >1. Obtaining electron back scatter ratios of e.g. 2 to 10 may be provided by electrons having a grazing incidence onto a scatter surface, e.g. a finned or whiskered surface, which may be additionally coated with beryllium oxide aluminum oxide or magnesium oxide. According coatings may be employed for dynodes of e.g. secondary electron multipliers.

Accordingly, the potential of an electron collecting element, embodied as a floating electrode element, may be changed to the positive and/or negative by a controlled impingement if electrons.

With a change in electron collecting element potential according to the present invention, transition times of about 10 to 20 μsec may be achievable. Maximum tube power may be available at low tube voltages, e.g. 120 kW at 80 kV. Photon flux may be considered to be sufficient even in high energy mode with part of the electron beam employed rather for changing electron collecting element potential than for generating X-radiation.

No feed through into the housing of the X-ray generating device, in particular no additional feed through except positive and negative high voltage or ground potential, may be required. External switching of high voltage may not be necessary due to intrinsic switching of the X-ray generating device. The pulse sequence may be arbitrarily selected. The size and/or dimensions of the focal spot may be maintained even for different anode potentials.

The scatter elements may be implemented as a wire grid and may be coated with oxides used for dynodes of secondary electron multipliers, like e.g. beryllium oxide, aluminum oxide and magnesium oxide or may have a structure or coating like salt of the formula xCl, xBr, metal surfaces comprising metallic elements U, Nb, W, Ta, Mo, Rh, Ti, Diamond crystals, doped Diamond crystals, Diamond foil, doped Diamond foil, Carbon Nano Tubes and/or Fullerenes. The oxide coating may only be applied in areas in which the average electron energy may be below 10 keV. A scatter structure comprising e.g. fins, wires or whiskers may be employed as a moderator structure or moderator element for slowing down impinging electrons.

In case of a diode element, the element may be implemented as a semiconductor, e.g. semiconductor in vacuum, or feed through, as a vacuum diode, e.g. a thermo-ionic electron emitter arranged adjacent to an auxiliary electron collecting element. A vacuum diode may be requiring energy transfer, e.g. comprising a transformer within the vacuum of the housing of the X-ray generating device for heating. The diode element may also be implemented as a cathode with field emitters as electron source, like carbon nano tubes, arranged adjacently or in front of an auxiliary electron collecting element, possibly requiring no power supply and no additional feed-through.

In case a resistor element is employed, the resistor element may be arranged externally of the housing of the X-ray generating device. However, the resistor element may also be integrated into the electron collecting element, e.g. by using resistive anode material like doped silicon carbide (SiC), possibly requiring no additional feed-through. In case an inductance element is employed, the inductance element may be an integrated part of the anode, e.g. a spiral-like wire structure or printed circuit board on an insulating part or body of the electron collecting element.

In the following, further embodiments of the present invention are described referring in particular to an X-ray generating device. However, these explanations also apply to the X-ray system, the use of an X-ray generating device in at least one of an X-ray system and a CT system and the method for switching electron collecting element potential.

It is noted that arbitrary variations and interchanges of single or multiple features between claims and in particular, claimed entities, are conceivable and with a scope and disclosure of the present patent application.

According to a further exemplary embodiment of the present invention, a first area of impingement of the electron beam on the electron collecting element may constitute a focal spot and the size and/or the location of the focal spot may be influenced by the electron beam.

By directing and/or focusing the electron beam towards the electron collecting element, the first area of impingement or the focal spot may be influenced, in particular controlled.

According to a further exemplary embodiment of the present invention, the X-ray generating device may further comprise a second area of impingement, wherein a first part of the electron beam is impingeable on the focal spot, wherein a second part of the electron beam is impingeable on the second area of impingement and wherein the second part of the electron beam may be adapted for influencing the potential.

Thus, by directing a part of the electron beam towards the second area of impingement a potential and/or a change in potential may be controllable.

According to a further exemplary embodiment of the present invention, the X-ray generating device may further comprise a second area of impingement and at least a second electron emitting element, wherein the second electron emitting element is adapted to provide a second electron beam for impingement on the second area of impingement.

By employing distinct electron emitting elements, thus distinct electron beams for generation of X-radiation and for providing a potential alteration of the electron collecting element, it may not be necessary to deflect, thus divide the primary electron beam. Accordingly, the full primary electron beam may be employed for the generation of X-radiation without the need to reduce the amount of electrons impinging on the focal spot. The distinct electron beams may be intensity modulated and/or may be switched of individually.

According to a further exemplary embodiment of the invention, the second area of impingement may be arranged on one element out of the group consisting of the electron collecting element and a supplementary electron collecting element.

By redirecting a part of the electron beam onto either a supplementary electron collecting element or a different part of the electron collecting element on which also the first area of impingement is arranged at, that part of the electron beam may be diverged from the useful electron beam that generates useful X-radiation, while being employed for changing a potential between the electron emitting element and the electron collecting element.

According to a further exemplary embodiment of the invention, the second area of impingement may be adapted for scattering of electrons, in particular comprising an electron scattering element, which electron scattering element may comprise at least one of a moderator element, a finned element, a whisker element, a grid wire and an element comprising one of a dynode coating, beryllium oxide (BeO), aluminum oxide (Al₂O₃), magnesium oxide (MgO), salt of the formula xCl, xBr, metal surfaces comprising metallic elements U, Nb, W, Ta, Mo, Rh, Ti, Diamond crystals, doped Diamond crystals, Diamond foil, doped Diamond foil, Carbon Nano Tubes and Fullerenes.

The scattering element may in particular be a surface or surface element. An according electron scattering element or electron scattering surface may allow providing multiple scatter electrons from a single electron of the electron beam impinging on the second area of impingement.

According to a further exemplary embodiment of the invention, the X-ray generating device may further comprise a scatter electron collecting element, wherein the scatter electron collecting element may be adapted to collect electrons scattered from the electron scattering surface. The electron collecting element may further be adapted to be at least one of positively chargeable and ionisable by impingement of electrons on the second area of impingement.

By scattering electrons, a part of the electron beam may be employed to constitute a conductive connection, e.g. within an evacuated housing of an X-ray generating device, between the electron collecting element and a further element, which further element, e.g. the scatter electron collecting element, may has a potential different from the initial potential of the electron collecting element, e.g. ground potential, to allow to provide a different potential to the electron collecting element via the stream of scattered electrons.

The scatter electron collecting element may be seen as a drain for receiving electrons, which are accelerated between the scattering element and the scatter electron collecting element due to a potential difference from the electron scatter electron surface to the scatter electron collecting element, possibly providing a conductive link to provide substantially similar potential to the electron scattering element and possibly the electron collecting element of the scatter electron collecting element. The electron back scatter ratio may be in particular larger than 1, e.g. between 2 and 10. Thus, for each electron impinging on the electron scattering surface, 2 to 10 scatter electrons are generated.

According to a further exemplary embodiment of the invention, the voltage supplied to the X-ray generating device may remain substantially unchanged when changing the potential between the electron emitting element and the electron collecting element.

Thus, no external voltage switching may be required, which may possibly be too slow, e.g. due to capacitance effects, for the beneficial acquisition of X-ray images.

According to a further exemplary embodiment of the invention, the X-ray generating device may comprise at least one element out of the group, consisting of a capacitance element, a parenthetic capacitance, a diode element, and inductive element and a resistive element, wherein the at least one element may be arranged between the electron collecting element and a potential between the most positive potential and the most negative supply potential, in particular ground potential.

By employing an according element, the electron collecting element may be decoupled, e.g. from ground potential, to obtain a floating electrode, which may subsequently allow to receive different potentials other than ground potential externally.

These other aspect of the present invention will become apparent from and elucidated with reference to the embodiments described herein-after.

Exemplary embodiments of the present invention will be described below with reference to the following drawings.

The illustration in the drawings is schematic. In different drawings, similar or identical elements are provided with similar or identical reference numerals.

Figures are not drawn to scale, however may depict qualitative proportions.

### BRIEF DESCRIPTION OF THE DRAWINGS

FIG. 1 shows an exemplary embodiment of an X-ray system according to the present invention;

FIG. 2 shows an exemplary embodiment of a circuit schematic for changing the potential of an electron collecting element according to a first embodiment of the present invention;

FIG. 3 shows an exemplary embodiment of a circuit schematic for changing the potential of an electron collecting element according to a second embodiment of the present invention;

FIG. 4 shows an exemplary time diagram of a potential switch according to the present invention;

FIGS. 5a-e show exemplary states of the schematic circuit of FIG. 3 within the timeline diagram of FIG. 4 according to the present invention;

FIG. 6 shows an exemplary embodiment of an electron collecting disc element according to the present invention;

FIG. 7 shows an exemplary X-ray beam geometry according to an exemplary embodiment of the present invention;

FIGS. 8a-9c show exemplary embodiments of electron back scattering;

FIGS. 10a-c show exemplary electron back scatter coefficient values according to the present invention; and

FIG. 11 shows an exemplary embodiment of a method for switching electron collecting element potential according to the present invention.

### DETAILED DESCRIPTION OF EMBODIMENTS

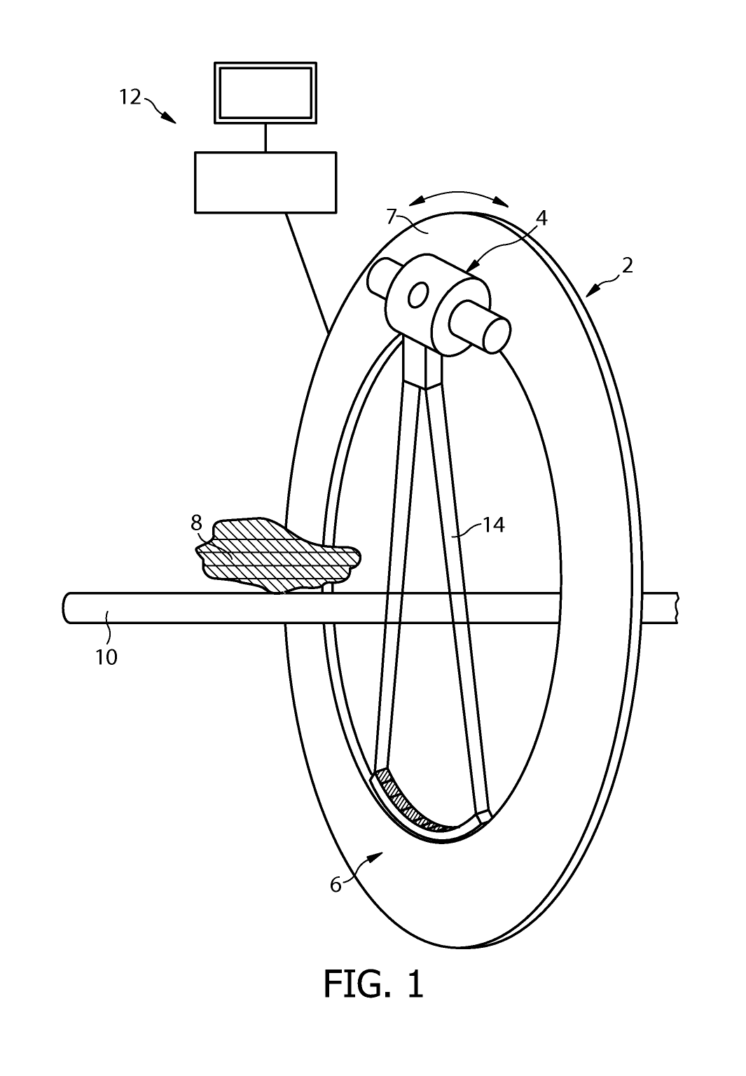

Now referring to FIG. 1, an exemplary embodiment of an X-ray system according to the present invention is depicted.

The X-ray system 2 of FIG. 1 comprises an X-ray generating device 4 as well as an X-ray detector 6, here exemplary depicted as a line array. Both, the X-ray generating device 4 and the X-ray detector 6 are mounted on gantry 7, opposing one another. X-radiation 14 is emanating from X-ray generating device 4 in the direction of X-ray detector 6. Situated on a support 10, an object 8 is arranged in the path of X-rays 14. The gantry 7 comprising the X-ray generating device 4 and the X-ray detector 6 may be rotated about object 8, e.g. a patient, for the acquisition of X-ray images. A computer system 12 is provided for controlling the X-ray system 2 and/or for evaluating acquired X-ray images.

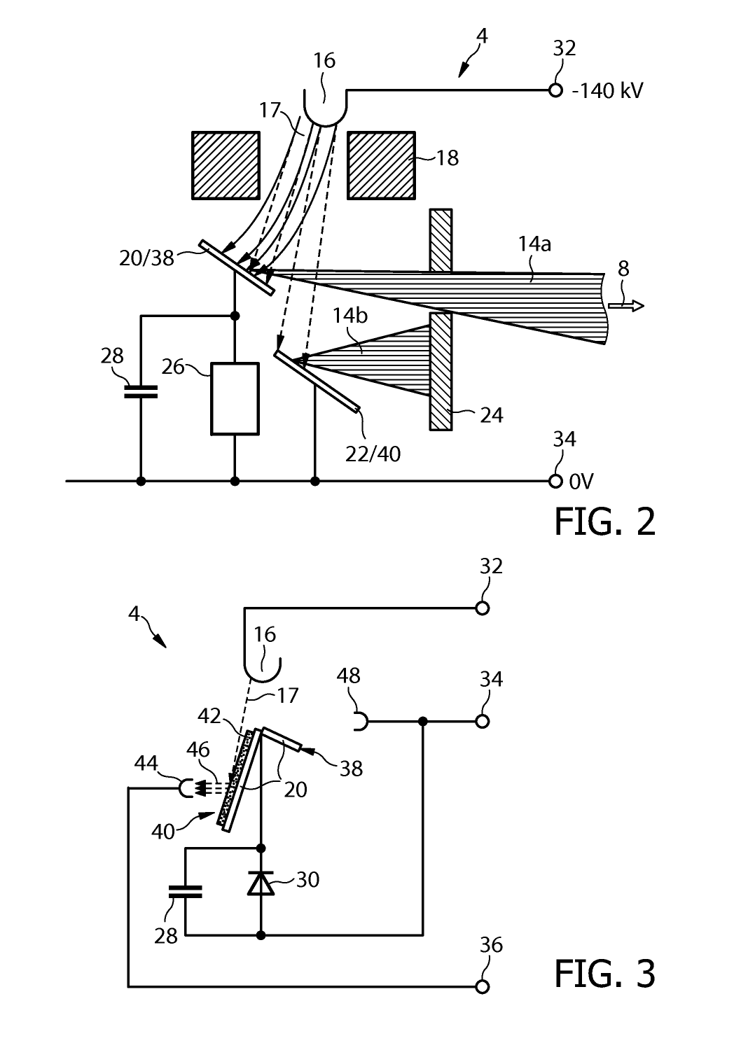

Now referring to FIG. 2, an exemplary embodiment of a circuit schematic for changing the potential of an electron collecting element according to a first embodiment of the present invention is depicted.

In FIG. 2, the X-ray generating device 4 is depicted exemplary as a unipolar X-ray generating device 4 comprising −140 kV 32 to the electron emitting element 16. The X-ray generating device 4 comprises an electron collecting element 20 as well as a supplementary electron collecting element 22. The supplementary electron collecting element 22 is connected directly to ground potential 34 having 0V and electron collecting element 20 is connected to ground potential 34 by resistive element 26, possibly having a parasitic capacitance 28 parallel to resistive element 26.

Due to the potential or voltage difference between electron emitting elements 16 and electron collecting elements 20,22, electrons are accelerated from the electron emitting element 16 to the electron collecting elements 20,22, constituting an electron beam 17.

The deflection elements 18 are employed for directing the electron beam 17 towards the electron collecting elements 20,22. Thus, by deflection elements 18, the electron beam 17 may be directed to either one of the electron collecting element 20 and the supplementary electron collecting element 22. The transition of the electron beam between both electron collecting elements 20,22 is achievable by the deflection element 18.

An aperture element or collimation element 24 is arranged for forming and/or shaping X-radiation 14 in the direction of object 8. The opening of aperture element 24 may allow the active or used X-radiation 14a to pass, thus leave the X-ray generating device 4, in the direction of object 8 and X-ray detector 6, while the aperture element 24 itself hinders inactive or unused X-radiation 14b from leaving the X-ray generating device 4. Aperture element 24 may be moved and its opening adjusted for determining a desired shape of X-radiation 14.

On electron collecting element 20, a focal spot 38 or first area of impingement 38 is arranged at and on supplementary electron collecting elements 22, a second area of impingement 40 is arranged at. The electron beam 17 may also be interpreted as a current emanating from electron emitting element 16 flowing to the electron collecting elements 20,22. In case the electron beam 17 is moved or displaced by deflection elements 18 from a position impinging only on electron collecting element 20 to also impinging on the second area of impingement 40 of the supplementary electron collecting element 22, the received current is divided by the electron collecting element 20 and the supplementary electron collecting element 22. Thus, by redirecting at least a part of the electron beam 17 towards supplementary electron collecting element 22, the current conducting through resistive element 26 is changed. Thus, the voltage over resistive element 26 may be adjusted accordingly. In other words, by redirecting at least a part of the electron beam 17 towards the supplementary electron collecting element 22, a potential between the electron emitting element 16 and the electron collecting element 20 may be influenced.

Thus, in case deflection elements 18 do not provide a seamless transition but rather a switch of the electron beam 17 between an impingement solely on electron collecting element 20 to an impingement on both electron collecting elements 20,22, the potential, thus the acceleration voltage, between the electron emitting element 16 and the electron collecting element 20 may be switched as well. The position and size of the opening of aperture element 24 may be adjusted in accordance with the effective first area of impingement 38 on electron collecting element 20.

In case only a single energy X-radiation 14 is desired, the electron beam 17 may be directed completely towards supplementary electron collecting element 22 by deflection elements 18 for generating X-radiation 14. In this case, aperture element 24 may be located at a position to allow X-radiation beam 14b to leave the housing of the X-ray generating device 4.

Capacitance 28 may e.g. be 150 pF, the resistive coupling or resistive element 26 may have e.g. 100 kΩ. The time constant for a transition in energy of X-radiation τ may e.g. be 15 μsec. X-rays 14 may have for example an energy of 60 to 140 keV.

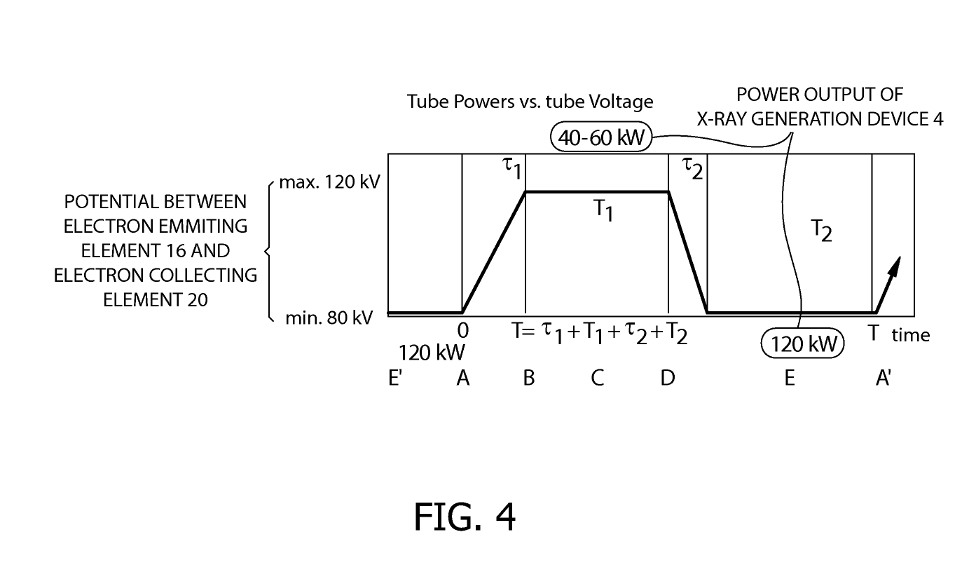

Now referring to FIG. 3, an exemplary embodiment of a circuit schematic for changing the potential of an electron collecting element according to a second embodiment of the present invention is depicted.

In FIG. 3, the circuit schematic of an X-ray generating device 4, comprising an electron collecting element 20, having a scatter element 42 is depicted.

Again, an electron beam 17 is emanating from electron emitting element 16 towards the electron collecting element 20. The electron collecting element itself comprises a focal spot 38 or first area of impingement 38 as well as a second area of impingement 40, comprising a scatter element 42. Deflection elements 18, not depicted in FIG. 3, may be employed for directing the electron beam 17 into either the first area of impingement 38 or the second area of impingement 40, possibly allowing a continuous transition as well as substantially switching the position of the electron beam 17 on the electron collecting element 20, at least in part.

Electron collecting element 20 is provided with a diode element 30 and connected by the diode element 30 to ground potential 34. Negative high voltage supply of a high voltage generator is provided to negative potential 32 connected to the electron emitting element 16. A positive high voltage supply of the high voltage generator may be connected to positive potential 36, to which the scatter electron collecting element 44 is connected to. A further scatter electron collecting element 48 is arranged at ground potential 34, connected to the electron collecting element 20 also by diode element 30 as well as parasitic capacitance 28 of the electron collecting element 20.

The further scatter electron collecting element 48 may be employed to pull electrons off the anode, which are scattered from the focal spot, where the used X-rays are created. The collection of these scattered electrons may help reduce the heat load of the anode, as they may otherwise return to the anode, in particular in case, the tube frame is negatively charged with respect to the anode or in case the cathode may act as an electron mirror, if it is arranged close to the focal spot.

A part of the electron beam 17 is impinging on the second area of impingement 40 and thus, by scatter element 42, back scatter electrons 56 are created, which are directed towards the scatter electron collecting element 44 by a potential between electron collecting element 20 and scatter electron collecting element 44, thus between ground potential 34 and positive potential 36.

As may be taken from FIG. 3, the scatter element 42 may be hit by electron beam 17 under a flat incidence angle for providing a back scatter co-efficient η, e.g. η=2 to 10.

In an example, negative voltage may be chosen to −80 kV, with positive potential may be chosen to +40 kV. Ground potential may thus be considered to be 0 kV. For generating 80 keV X-radiation, the full primary electron beam 17 is directed towards the first area of impingement, the focal track 38, of electron collecting element 20: Full power, thus the complete current of the electrons of electron beam 17, is available for generating X-radiation 14 with the diode element 30 being in a conducting state.

For generating X-radiation 14 having increased energy, the electron collecting element 20, in particular its potential may be increased to +40 kV. Accordingly, the potential between electron emitting element 16 and electron collecting element 20 is increasing as well. To drive the potential of the electron collecting element 20 towards +40 kV, a part of the primary electron beam 17 is directed towards scatter surface 42 by deflection elements 18. Scattered electrons 46 are then pulled off towards the scatter electron collecting element 44 having a potential of +40 kV. With a scatter coefficient η>1, the electron collecting element 20 may be considered to charge positively, thus ionize, maintaining this potential as long as the scatter process continues, in other words, as long as a part of the primary electron beam 17 is directed towards scatter element 42.

The remaining part of electron beam 17 is still directed towards the focal spot 38, for generating X-radiation 14, in this case roughly 120 keV X-radiation, due to the increased potential between electron emitting element 16 and electron collecting element 20. To accelerate the transition of potentials, the full primary beam 17 may be directed to the scatter surface 42 for the transition period. To charge back to regular potential, thus e.g. 80 kV, the electron beam 17 is directed away from the scatter surface 42.

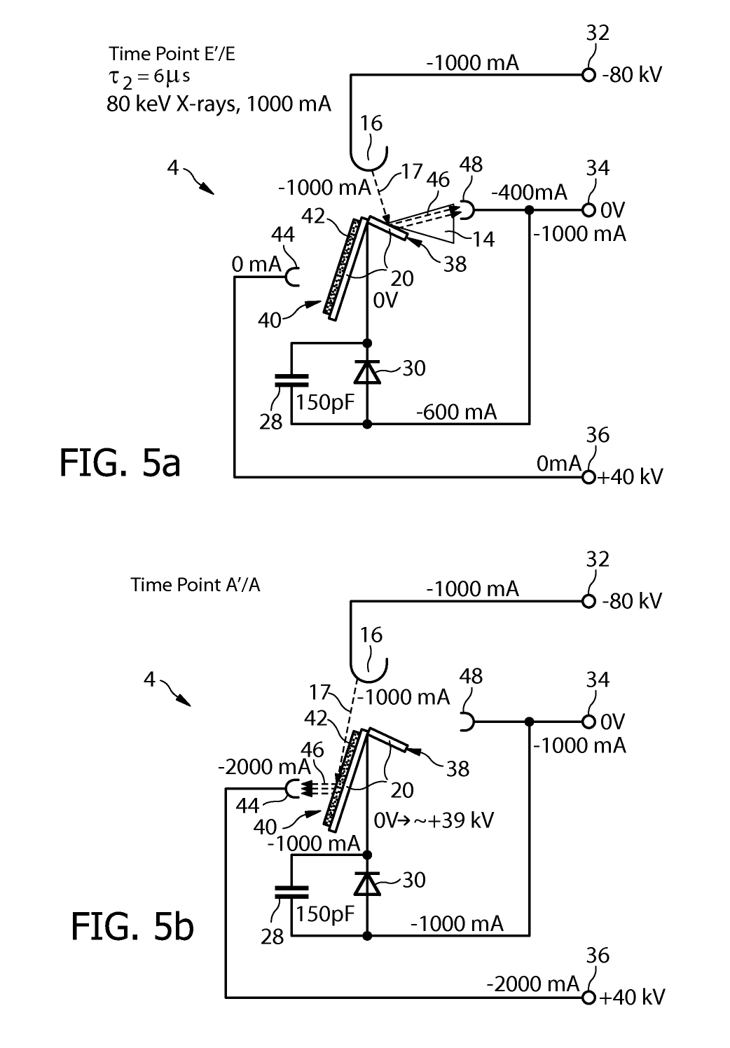

Now referring to FIG. 4, an exemplary embodiment of a circuit schematic for changing the potential of an electron collecting element according to a second embodiment of the present invention is depicted.

In FIG. 4, a complete transition period between time point A and the next time point A′ is depicted. At point A, the potential between electron emitting element 16 and electron collecting element 20 is 80 kV. During a transition time τ₁, a part of the electron beam 17 is directed towards scatter element 42. Thus, electron collecting element 20 is positively charged to about +40 kV, arriving at an overall potential between electron emitting element 16 and electron collecting element 20 of about 120 kV.

This high potential mode of operation may continue between time point B and time point D for the duration of T₁ by time duration C. In the high potential mode, the overall mode power for active X-radiation 14a may be reduced from 120 kW in low potential mode to 40 to 60 kW in high potential mode.

At time point D, electron beam 17 is directed back to the focal spot 38 only, thus not impinging any more on scatter element 42. During transition time τ₂, the potential between electron emitting element 16 and the electron collecting element 20 returns from about 120 kV to 80 kV, which may be employed during time period E for the time T₂ for generating X-radiation, again with absolute power of 120 kW. After the time period T, at time point A′, the depicted cycle may be repeated.

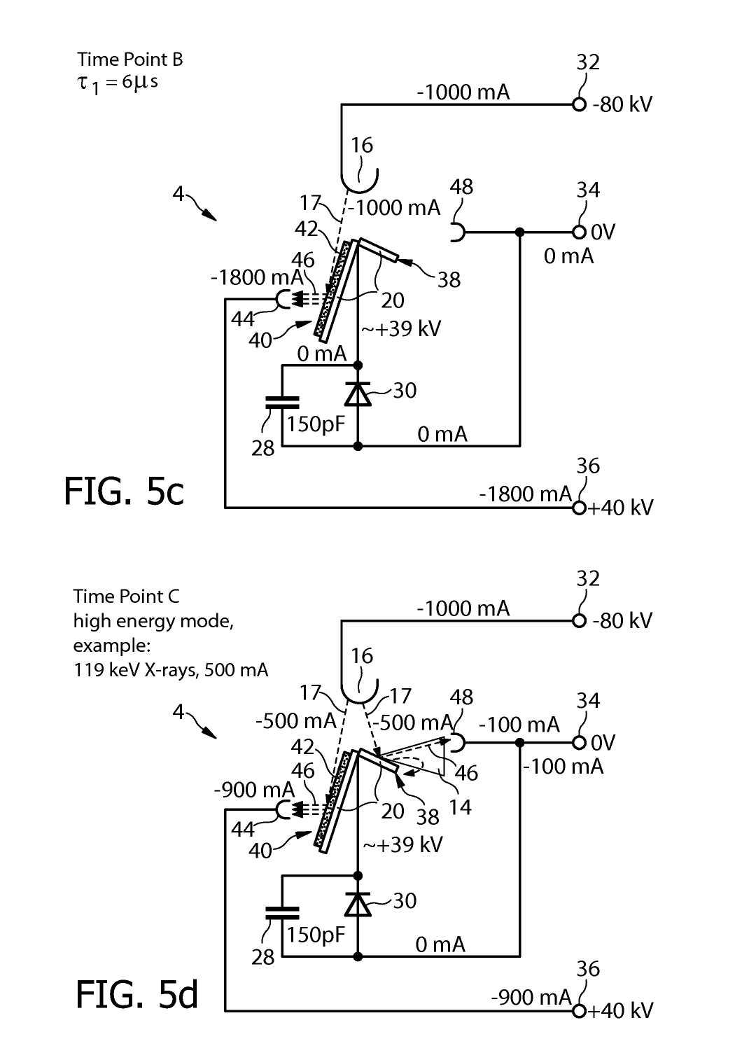

Now referring to FIGS. 5a to 5e, exemplary states of the schematic circuit of FIG. 3 within the timeline of FIG. 4 according to the present invention are depicted.

In FIG. 5a, the operation of an X-ray generating device 4 during time period E/E′ is depicted. X-ray beam 17 is directed by displacement elements 18, not depicted in FIGS. 5a-e, towards focal spot 38 of electron collecting element 20. The potential of the electron collecting element 20 is substantially ground potential 34. Electrons impinging of focal spot 38, here exemplary being a current of −1000 mA, are divided into a scattering part 46 directed towards the further scatter electron collecting element 48, e.g. −400 mA, and a part directed towards ground potential, e.g. −600 mA, via diode element 30.

Both values −400 mA and −600 mA sum up to −1000 mA, as provided by the electron emitting element 16. During the time period E X-radiation having 80 keV is generated.

With regard to FIG. 5b, time point A/A′ is depicted. In time point A, the complete electron beam 17 is directed by deflection elements 18 towards scatter element 42. Again, an exemplary current of −1000 mA is provided to the electron collecting element 20, which is, at the beginning of the transition period between time point A and B, substantially connected to ground potential. The electron beam 17 impinging on the scatter element 42 is generating scatter electrons 46, which are directed towards scatter electron collecting element 44, connected to a potential 36 of +40 kV.

In FIG. 5b, an exemplary scatter ratio of 2 is assumed, thus a current of −1000 mA is generating a current between the scatter element 42 and the scatter electron collecting element 44 of −2000 mA. Since time point A is the beginning time point of the transition phase τ₁, the potential of the electron collecting element 20 is beginning to raise from 0 volts to approximately 39 kV.

In FIG. 5c, the X-ray generating device 4 in time point B is depicted. The electron beam 17 is still directed towards scatter element 42. In time point B, the potential of the electron collecting element 20 has been raised to about +39 kV, thus being approximately equal to positive potential 36. In this case, the pull field between the scatter element 42 and the scatter electron collecting element 44 approaches 0, due to an almost identical potential, with the scatter coefficient η falling e.g. from 2.0 to 1.8, as an example, thus resulting in a scatter electron current of −1800 mA from scatter element 42 to scatter electron collecting element 44.

No current is passing diode element 30 towards ground potential, since diode element, in this case, is in reverse direction. In this particular example, in a transition time between time point A and B, with τ₁ exemplary being 6 μs, no useful X-rays may be generated.

With regard to FIG. 5d, in time period C, T₁, a part of the electron beam 17 is directed continuously towards scatter element 42, again having an exemplary scatter coefficient of 1.8, thus producing −900 mA by an impinging current of −500 mA on scatter element 42. The further part of the current of electron beam 17 is directed towards focal spot 38 for generating useful X-radiation 14. In this case, X-radiation 14 having an energy of 119 keV is created, however, only by a current of 500 mA.

Electrons from the focal track 38 may be back scattered as well against a repelling field, having e.g. a back scatter coefficient η of 0.2, resulting in a current of −100 mA towards ground potential. Slow scattered electrons may return to the anode by themselves.

With regard to FIG. 5e, in time point D, the back transition phase, having the duration of τ₂ is initiated by directing the electron beam 17 only towards focal spot 38. X-rays 14 generated have a decreasing energy from 119 keV to 80 keV, while the electron collecting element 20 returns its potential from about +39 kV to 0 kV, thus ground potential 34. Back scattered electrons 46 from the focal track 38 may be collected by the further scatter electron collecting element 48, having a back scatter coefficient η of about 0.4, thus resulting in a current of −400 mA.

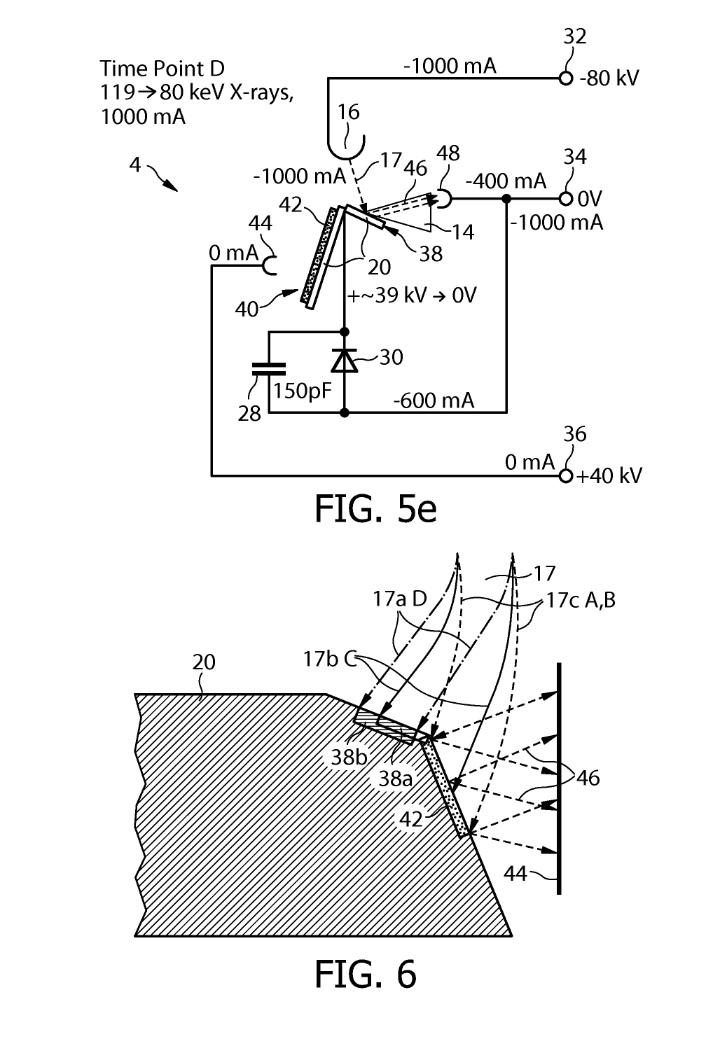

Now referring to FIG. 6, an exemplary embodiment of an electron collecting disc element according to the present invention is depicted.

In FIG. 6, it is assumed that starting from low energy mode, the primary electron beam 17,17a is directed towards the focal track 38b, constituting the main focal track in low energy mode for generating X-radiation 14 at substantially full power of the X-ray generating device 4 or X-ray tube.

For a fast transition to high energy mode, electron beam 17 is radially swept 17c towards scatter element 42. Due to a flat angle of incidence, the physical focal spot length is expanded. Thus, it may be conceivable that even a ceramics surface may be able to withstand the thermal load generated by the impinging electron beam 17c. From the scatter element 42, scatter electrons 46 are generated, which are directed towards scatter electron collecting element 44. Scattered electrons 46 may thus be considered to recharge the electron collecting element 20 until the high energy mode is reached.

The electron beam 17 is swept back to constitute electron beam 17b, in this case employing the focal track 38a in high energy mode, for generating useful X-radiation 14 until the transition is completed after τ₁.

As the primary current of the electron emitting element 16 remains unchanged, the power output of the X-ray generating device 4 rises in accordance with the voltage or potential difference between the electron emitting element 16 and the electron collecting element 20, e.g. by 150% from 80 kV to about 120 kV. A different focal track 38 in high energy mode may be required due to an increase in power density, in case beam focusing by deflection elements 18 remain unchanged, the focal spot length or width or both may have to be increased compared to the focal track in low energy mode 38b. It may be in particular beneficial to enlarge the focal spot length during the transition period by the same ratio as the increase in potential, e.g. 150%.

To keep the focal power density on the X-ray generating part of the focal track constant, the focusing parameters may have to be adapted to the increase in voltage or potential. Accordingly in high energy mode, the length of that part of the focal spot in which useful X-rays are generated may be shorter than in low energy mode, where the full length of the focal spot is located on the surface 38a, generating X-rays.

E.g. if half of the focal spot would be located on the surface 38, where useful X-rays are being generated, and half of it would be located on the scatter surface 42 and if in high energy mode the total length of the focal spot has to be increased to 150% of the length in low energy mode, to keep the power density constant, the length of the part of the focal spot which generates useful X-rays is 150%:2=75% of the length which generates useful X-rays in low energy mode In other words, the X-ray optical focal spot would shrink by 25% when going from low energy mode to high energy mode. In this instance, in high energy mode only half of the electrons which hit the anode would generate useful X-ray. This is no major deficit, as the X-ray flux generated in high energy mode per unit current is increasing according to a well known square law with the high voltage potential, and therefore the absolute flux is about constant in this example. The X-ray optical characteristics may even improve due to the smaller focal spot size (length).

Some less intensive X-rays, which may enter the used X-ray beam 14, thus may be emitted by an edge of the scatter element 42.

The transition between high energy mode and low energy mode may be accelerated in case the width and length of the focal spot may be changed simultaneously, to avoid overheating of the focal track 38 or the scatter surface 42.

For a back transition to low energy mode, the electron beam 17 is completely directed to focal track 38b. The scatter element 42 is thus not receiving electrons any more. Accordingly, the potential of the electron collecting element 20 will become more negative until the diode element opens and connects it to ground potential 34. Focusing parameters of the deflection elements 18 may be returned to a low energy setting as compared to a previously high energy setting. Thus, the transition may be considered to be completed after period τ₂.

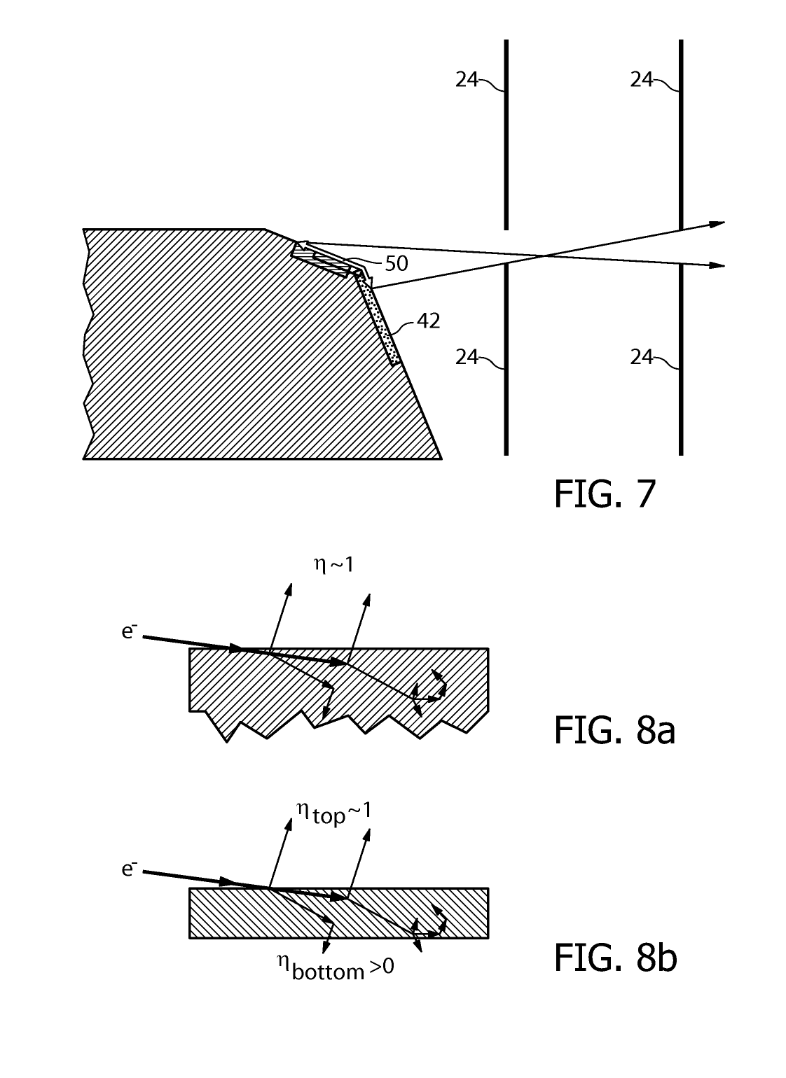

Now referring to FIG. 7, an exemplary X-ray beam geometry according to an exemplary embodiment of the present invention is depicted.

As previously described with reference to FIG. 6, the active area 50 from which X-rays enter the used X-ray fan beam is situated on focal track 38, as well as a minor part of the scatter element 42. However, electrons which hit the scatter element 42 may be considered to not significantly contribute to the used X-ray beam 14, due to the aperture element 24 having an accordingly adjusted opening blocking the path. Thus, substantially only X-radiation 14 generated at the focal spot 38 may leave the X-ray generating device 4 for generating an X-ray image.

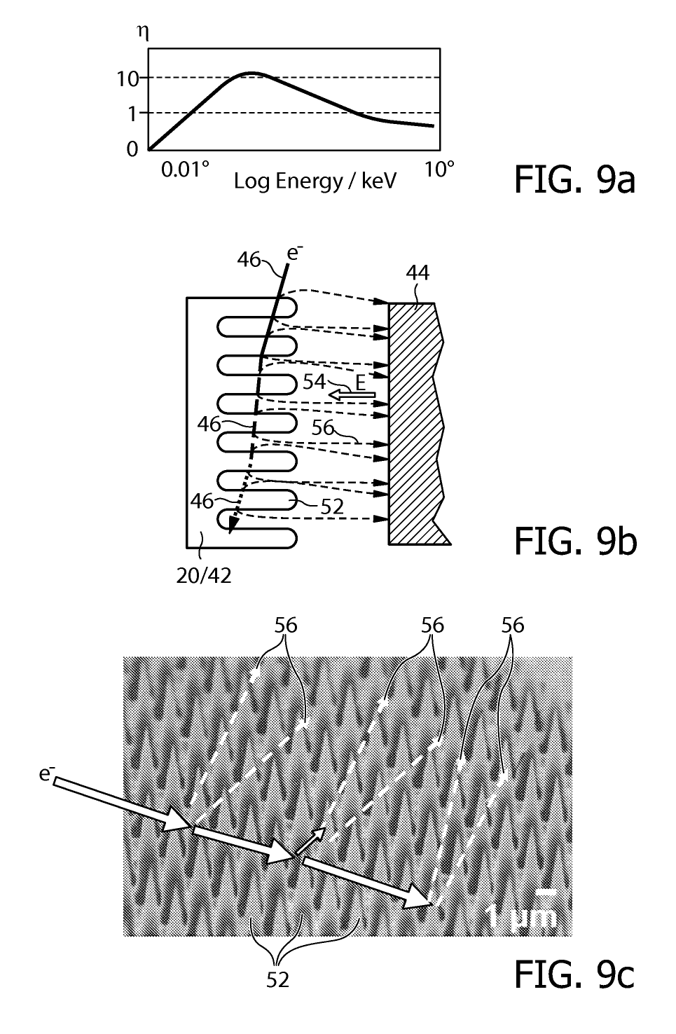

Now referring to FIGS. 8a to 9c, exemplary embodiments of electron back scattering are depicted.

In FIG. 8a, a scatter ratio η of about 1 is depicted. An electron with grazing incidence, thus a small angle of incidence, is entering into e.g. an electronically opaque surface like gold or tungsten. The electron, which is travelling within the structure, however close below the surface of e.g. a tungsten body, may interact multiply with electrons. 50% of the scatter electrons may be considered to be released into the vacuum hemisphere of the X-ray generating device 4, thus constituting to about a scatter ratio of 1. The remaining 50% may get lost in the body due to multiple scattering within the body. These would be at least partly be available for release as well.

With regard to FIG. 8b, in case the body of FIG. 8a may be considered to be foil or being a sort of a finned structure or whiskered structure, at least a part of the electrons otherwise lost in the body, may also be released into the vacuum, in particular on the opposing side of where the electron entered the body. This may hold in particularly true in case the thickness of the foil is within the range of the penetration depth of impinging electrons. Accordingly, a scatter ratio η>1 may be achievable by η=ηₜₒₚ+η_{bottom}>1.

With regard to FIG. 9, the back scatter ratio η is depicted vs. energy.

Dynode coatings like e.g. beryllium oxide, magnesium oxide and aluminum oxide may provide an electron scatter coefficient η of 2 to 10. Employing a sandwich structure, which employs a high-z-material like tungsten as a bottom layer, which may effectively scatter high energy electrons, and an additionally coating on top of the bottom layer with an according dynode coating or a mixture of the mentioned coating to enhanced secondary electron emission may be in particular beneficial.

With regard to FIGS. 9b,c, employing a finned structure or a whiskered structure for generating back scattered electrons 56 is depicted. The back scattering under grazing incidence may further be enhanced by a rough structure, in particular surface structure, having fins or whiskers. The protruding elements may in particular be thinner than the average penetration depth of impinging electrons 46. Thus, back scattered electrons 56 may be released from both the top side and the rear side of an individual fin, thus obtaining a scatter gain of >2, which results in a scatter ratio η≧2.0, e.g. for tungsten having e.g. 80 to 150 keV.

A scatter electron 46 is entering a comb structure of the scatter element 42 having individual whiskers or fins 52. The electron, while individually penetrating multiple whiskers, is generating back scattered electrons 56, both when entering and leaving a single fin or whisker 52. The back scattered electrons 56 are accelerated by an electrical field 54 towards the scatter electron collecting element 44. Thus, a single scatter electron 46 may generate multiple back scattered electrons 56, e.g. 10, so resulting in a back scatter ratio η=10.

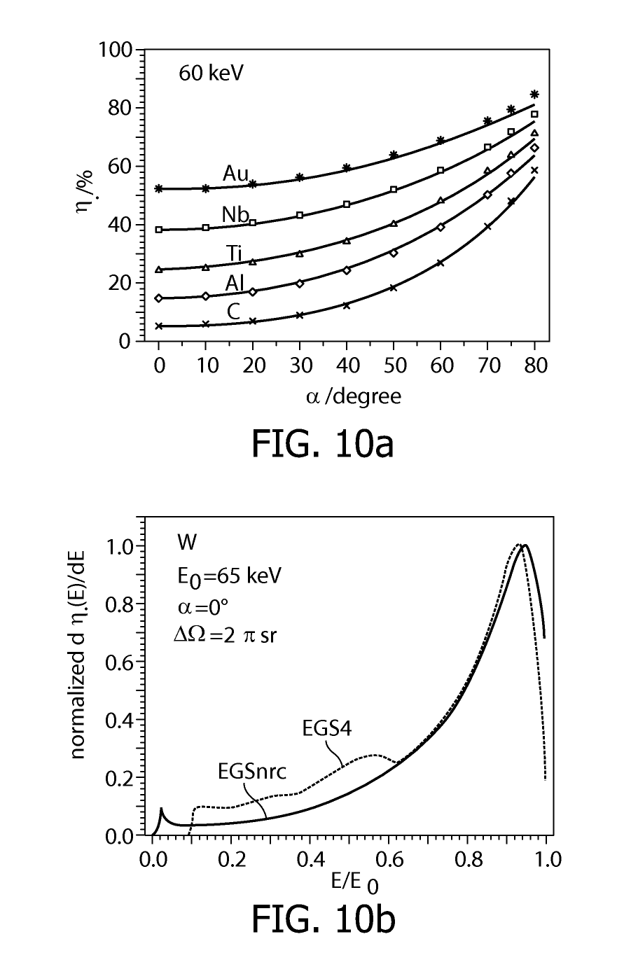

Now referring to FIGS. 10a to 10c, exemplary electron back scatter coefficient values according to the present invention is depicted.

FIG. 10a, the electron back scatter coefficient η versus angle of incidence α for a 60 keV electron beam is depicted.

With regard to FIG. 10b, the overall energy spectrum of 65 keV electrons back scattered from a semi-infinite tungsten target is depicted. It may be taken from FIG. 10b, that despite a large number of electrons is backscattered nearly elastically, the average energy of the scattered electrons is significantly lower than the primary energy. After multiple scatter events e.g. from W-surfaces, the scattered electrons are slowed down. Such an arrangement may be used as a moderator element, which brings the average electron energy down into a range, where other materials have a high scatter yield η.

With regard to FIG. 10c, the electron back scatter coefficient η versus atomic number of a sample material Z for electrons with incident kinetic energy of 30 keV is depicted. Particularly, high-z elements provide a high scatter coefficient η and are useful as moderator elements.

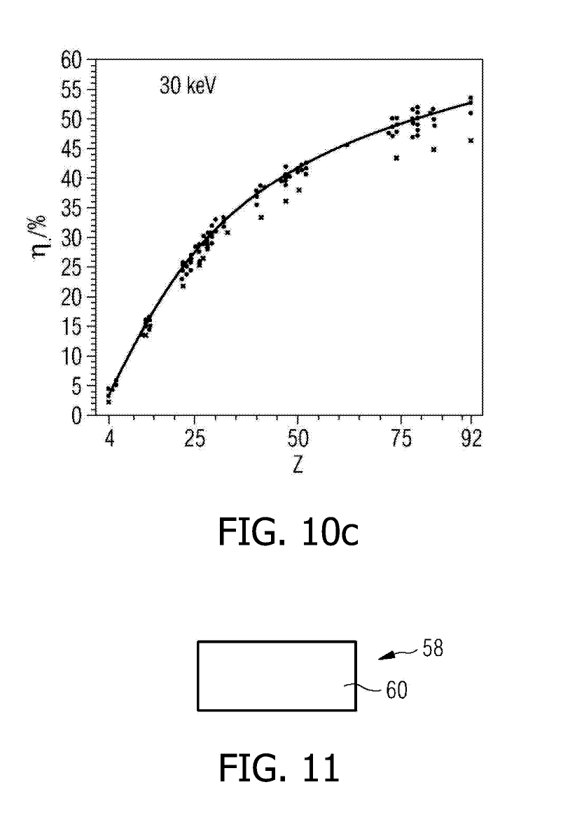

With regard to FIG. 11, a method for switching electron collecting element potential is depicted.

The method 58 for switching electron collecting element potential comprises providing 60 an electron beam 17 from an electron emitting element 16 to a first area of impingement 38 of an electron collecting element 38 for generating X-radiation 14, wherein the electron beam 17 may be provided, at least in part, to a second area of impingement 40 for changing a potential between the electron emitting element 16 and the electron collecting element 38.

It should be noted that the term “comprising” does not exclude other elements or steps and that “a” or “an” does not exclude a plurality. Also, elements described in association with different embodiments may be combined. It should also be noted that reference numerals in the claims shall not be construed as limiting the scope of the claims.

### REFERENCE NUMERALS

2 X-system
4 X-ray generating device
6 X-ray detector
7 gantry
8 object
10 support
12 X-radiation
16 electron emitting element
17a,b,c electron beam
18 deflection elements
20 electron collecting element
22 supplementary electron collecting element
24 aperture element/collimation element
26 resistive element/inductive element
28 parasitic capacitance/capacitance
30 diode element
32 negative potential
34 ground potential
36 positive potential
38a,b focal spot/first area of impingement
40 second area of impingement
42 scatter element
44 scatter electron collecting element
46 scatter electrons
48 further scatter electron collecting element
50 active area
52 fin/whisker
54 electric field
56 back scatter electron
58 method for switching electron collecting element potential
60 STEP: providing an electron beam

1. X-ray generating device (4), comprising at least one electron emitting element (16); and
at least one electron collecting element (20);
wherein the electron emitting element (16) and the electron collecting element (20) are operatively coupled for the generation of X-radiation (14);
wherein a potential is arranged between the electron emitting element (16) and the electron collecting element (20) for acceleration of electrons from the electron emitting element (16) to the electron collecting element (20), the electrons constituting at least one electron beam (17); and
wherein the electron beam (17) is adapted to influence the potential.

2. X-ray generating device according to claim 1,
wherein a first area of impingement (38) of the electron beam (17) on the electron collecting element (20) constituted a focal spot (38); and
wherein the size and/or the location of the focal spot (38) may be influenced by the electron beam (17).

3. X-ray generating device according to claim 1, further comprising
a deflection element (18),
wherein the defection element (18) is adapted to influence the size and/or location of the electron beam (17) on the electron collecting element (20).

4. X-ray generating device according to claim 1, further comprising
a second area of impingement (40);
wherein a first part of the electron beam (17) is impingeable on the focal spot (38);
wherein a second part of the electron beam (17) is impingeable on the second area of impingement (40); and
wherein the second part of electron beam (17) is adapted for influencing the potential.

5. X-ray generating device according to claim 1, further comprising
at least a second electron emitting element; and
at least a second area of impingement (40);
wherein the second electron emitting element is adapted to provide a second electron beam for impingement on the second area of impingement (40).

6. X-ray generating device according to claim 4,
wherein the second area of impingement (40) is arranged on one element out of the group consisting of the electron collecting element (20) and a supplementary electron collecting element (22).

7. X-ray generating device according to claim 4,
wherein the second area of impingement (40) is adapted for the scattering of electrons, in particular comprises an electron scattering element (42)

8. X-ray generating device according to claim 7,
wherein the electron scattering element (42) comprises at least one of a surface, a surface element, a moderator element, a finned element, a whisker element, a wire grid and an element comprising one of a dynode coating, beryllium oxide (BeO), aluminum oxide (Al₂O₃), magnesium oxide (MgO), salt of the formula xCl, xBr, metal surfaces comprising metallic elements U, Nb, W, Ta, Mo, Rh, Ti, Diamond crystals, doped Diamond crystals, Diamond foil, doped Diamond foil, Carbon Nano Tubes, Fullerenes.

9. X-ray generating device according to claim 4, further comprising
at least one scatter electron collecting element (44);
wherein the scatter electron collecting element (44) is adapted to collect electrons scattered from the electron scattering surface (42).

10. X-ray generating device according to claim 4,
wherein the electron collecting element (20) is adapted to be at least one of positively chargeable and ionizable by impingement of electrons on the second area of impingement (40).

11. X-ray generating device according to claim 1,
wherein the voltage supplied to the X-ray generating device (4) remains substantially unchanged when changing the potential between the electron emitting element and the electron collecting element.

12. X-ray generating device according to claim 1, further comprising
at least one element out of the group consisting of a parasitic capacitance (28), a diode element (30), an inductance element (26) and a resistive element (26);
wherein the at least one element is arranged between the electron collecting element (20) and a potential between the most positive potential and the most negative supply potential.

13. X-ray system, comprising
an X-ray generating device (4) according to claim 1; and
an X-ray detector (6);
wherein an object (8) is arrangeable between the X-ray generating device (4) and the X-ray detector (6); and
wherein the X-ray generating device (4) and the X-ray detector (6) are operatively coupled such that an X-ray image of the object (8) is obtainable.

14. Use of an X-ray generating device (4) according to claim 1 in at least one of an X-ray system and a CT system.

15. Method (58) for switching electron collecting element potential, comprising providing (60) an electron beam (17) from an electron emitting element (16) to a first area of impingement (38) of an electron collecting element (38) for generating X-radiation (14);
wherein the electron beam (17) may be provided, at least in part, to a second area of impingement (40) for changing a potential between the electron emitting element (16) and the electron collecting element (38).
